(19) United States
(12) Patent Application Publication
(10) Pub. No.: US 2026/0205617 A1
(43) Pub. Date: Jul. 16, 2026

(54) SUBBLOCK-BASED SPATIAL MOTION VECTOR PREDICTION

(71) Applicant: Tencent America LLC, Palo Alto, CA (US)

(72) Inventors: Lien-Fei CHEN, Palo Alto, CA (US); Biao WANG, San Jose, CA (US); Yifan WANG, Palo Alto, CA (US); Shan LIU, San Jose, CA (US); Roman CHERNYAK, Santa Clara, CA (US); Yonguk YOON, Palo Alto, CA (US); Ziyue XIANG, Palo Alto, CA (US)

(73) Assignee: Tencent America LLC, Palo Alto, CA (US)

(21) Appl. No.: 19/367,797

(22) Filed: Oct. 23, 2025

Related U.S. Application Data
(60) Provisional application No. 63/745,251, filed on Jan. 14, 2025.

(51) Int. Cl. H04N 19/52; H04N 19/176

(52) U.S. Cl. CPC H04N 19/52; H04N 19/176

(57) ABSTRACT

Coded information indicates that a bi-directional subblock-based spatial motion vector prediction (SbSMVP) is applied to a current block. A first subblock motion vector field is determined based on a plurality of top neighboring subblocks positioned at a top side of the current block. A second subblock motion vector field is determined based on a plurality of side neighboring subblocks positioned at a left side of the current block. According to a spatial direction, a motion vector for a first subblock of the current block is determined based on at least one of a first motion vector determined from the first subblock motion vector field and a second motion vector determined from the second subblock motion vector field. The first subblock of the current block is reconstructed based on the determined motion vector for the first subblock.

### INCORPORATION BY REFERENCE

The present application claims the benefit of priority to U.S. Provisional Application No. 63/745,251, “SUBBLOCK-BASED SPATIAL MOTION VECTOR PREDICTION” filed on Jan. 14, 2025, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of video decoding is provided. In the method, a video bitstream is received. The video bitstream includes coded information of a current block in a current picture of a video. The current block includes a plurality of subblocks. The coded information indicates that a bi-directional subblock-based spatial motion vector prediction (SbSMVP) is applied to the current block. A first subblock motion vector field is determined based on a plurality of top neighboring subblocks positioned at a top side of the current block. A second subblock motion vector field is determined based on a plurality of side neighboring subblocks positioned at a left side of the current block. According to a spatial direction, a motion vector for a first subblock of the current block is determined based on at least one of a first motion vector determined from the first subblock motion vector field and a second motion vector determined from the second subblock motion vector field. The first subblock of the current block is reconstructed based on the determined motion vector for the first subblock.

According to another aspect of the disclosure, a method of video encoding is provided. Whether a bi-directional SbSMVP is to be applied to a current block in a current picture is determined. The current block includes a plurality of subblocks. When the bi-directional SbSMVP is determined to be applied to the current block, a first subblock motion vector field is determined based on a plurality of top neighboring subblocks positioned at a top side of the current block. A second subblock motion vector field is determined based on a plurality of side neighboring subblocks positioned at a left side of the current block. According to a spatial direction, a motion vector for a first subblock of the current block is determined based on at least one of a first motion vector determined from the first subblock motion vector field and a second motion vector determined from the second subblock motion vector field. The first subblock of the current block is encoded based on the determined motion vector for the first subblock.

According to yet another aspect of the disclosure, a non-transitory computer-readable storage medium is provided. The non-transitory computer-readable storage medium stores instructions which when executed by a processor cause the processor to perform an encoding method. In the encoding method, whether a bi-directional SbSMVP is to be applied to a current block in a current picture is determined. The current block includes a plurality of subblocks. When the bi-directional SbSMVP is determined to be applied to the current block, a first subblock motion vector field is determined based on a plurality of top neighboring subblocks positioned at a top side of the current block. A second subblock motion vector field is determined based on a plurality of side neighboring subblocks positioned at a left side of the current block. According to a spatial direction, a motion vector for a first subblock of the current block is determined based on at least one of a first motion vector determined from the first subblock motion vector field and a second motion vector determined from the second subblock motion vector field. The first subblock of the current block is encoded in a bitstream based on the determined motion vector for the first subblock. The encoded bitstream is further transmitted.

Aspects of the disclosure also provide an apparatus for video decoding. The apparatus for video decoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods.

Technical solutions of the disclosure include methods and apparatuses to improve subblock-based spatial motion vector prediction based on bi-directional subblock-based spatial motion vector prediction. In an example, a video bitstream is received. The video bitstream includes coded information of a current block in a current picture of a video. The current block includes a plurality of subblocks. The coded information indicates that a bi-directional subblock-based spatial motion vector prediction (SbSMVP) is applied to the current block. A first subblock motion vector field is determined based on a plurality of top neighboring subblocks positioned at a top side of the current block. A second subblock motion vector field is determined based on a plurality of side neighboring subblocks positioned at a left side of the current block. According to a spatial direction, a motion vector for a first subblock of the current block is determined based on at least one of a first motion vector determined from the first subblock motion vector field and a second motion vector determined from the second subblock motion vector field. The first subblock of the current block is reconstructed based on the determined motion vector for the first subblock. Therefore, coding efficiencies and accuracies of subblock-based spatial motion vector prediction are improved based on bi-directional subblock-based spatial motion vector prediction.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4A is a schematic illustration of a first example of subblock-based temporal motion vector prediction (SbTMVP).

FIG. 4B is a schematic illustration of a second example of SbTMVP.

FIG. 4C is a schematic illustration of a third example of SbTMVP.

FIG. 4D is a schematic illustration of a fourth example of SbTMVP.

FIG. 4E is a schematic illustration of a fifth example of SbTMVP.

FIG. 5 is a schematic illustration of a first example of bi-directional SbTMVP.

FIG. 6 is a schematic illustration of a second example of bi-directional SbTMVP.

FIG. 7 is a schematic illustration of a third example of bi-directional SbTMVP.

FIG. 8 is a schematic illustration of a fourth example of bi-directional SbTMVP.

FIG. 9 is a schematic illustration of a fifth example of bi-directional SbTMVP.

FIG. 10 is a schematic illustration of a sixth example of bi-directional SbTMVP.

FIG. 11 is a schematic illustration of a seventy example of bi-directional SbTMVP.

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

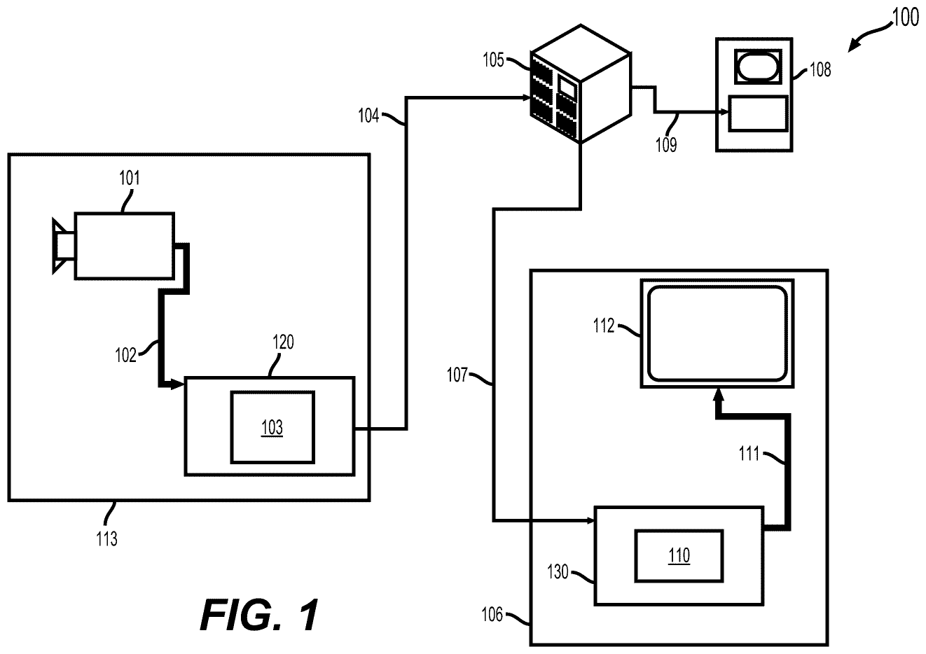

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

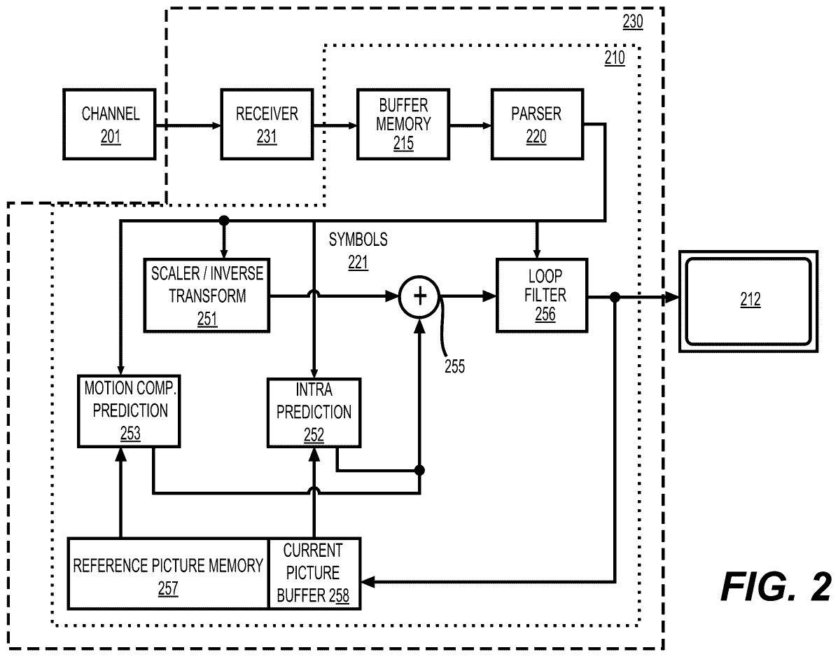

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

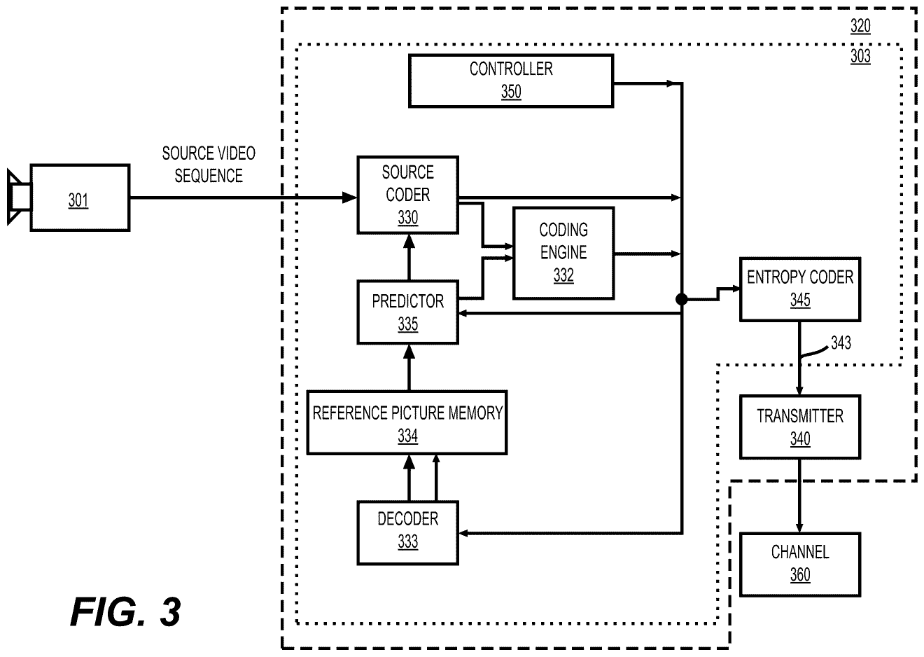

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques related to improvement of subblock-based spatial motion vector prediction.

Video coding has been widely used in many applications, such as broadcasting, video recording, and video streaming. Many emerging video coding standards, such as H.264, H.265/HEVC, H.266/VVC, and AV1 are published and widely adopted in these video applications. A hybrid video codec may include various coding modules, such as intra prediction, inter prediction, transform coding, quantization, entropy coding, and post in-loop filter.

Leveraging high-order deformation models for representing fine-granular motion between a current picture and a reference picture of the current picture is expected to achieve a high-quality prediction with less side information of model parameters. As a representative high-order model, an affine model is extensively studied in combination with existing video coding standards, such as AV1 and VVC.

Another way of reducing overhead of transmitting motion parameters is to derive motion parameters at a decoder side. The decoder-side motion information derivation may not only be derived at a coding block level but also derived at a subblock-level. A subblock concept may also be applied, for example in VVC, to extend a CU level temporal motion vector prediction (TMVP), which is referred to as subblock-based TMVP (SbTMVP).

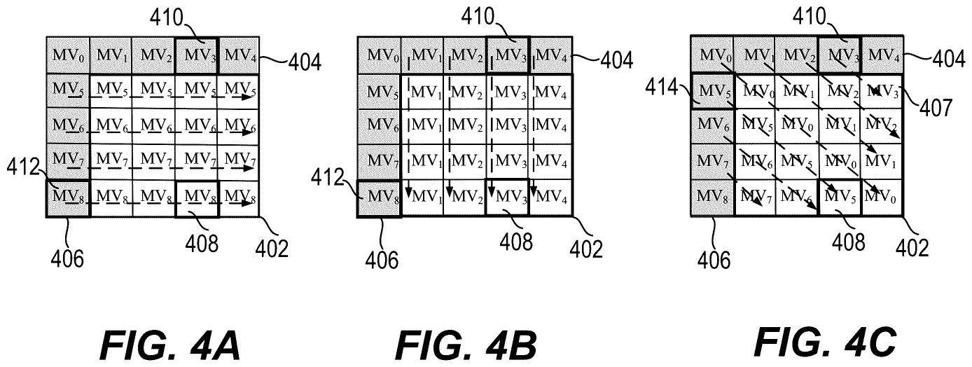

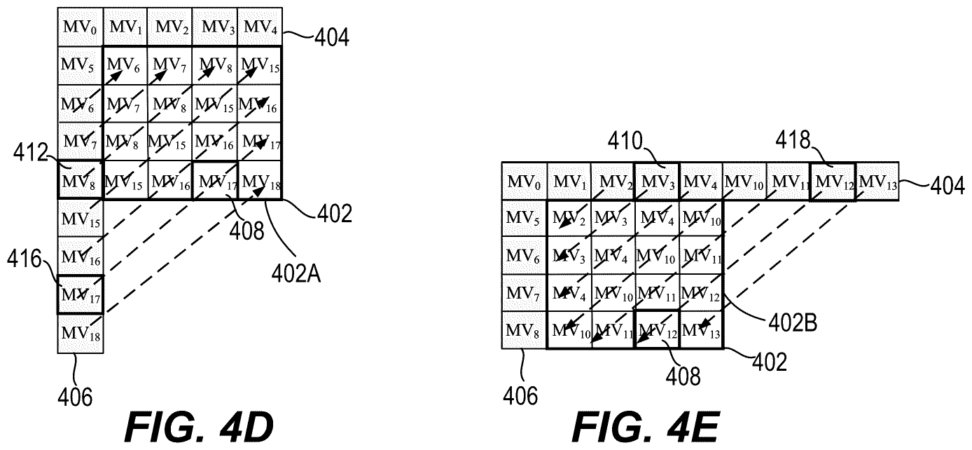

In a related example, subblock-based spatial MVP (SbSMVP) can be used to determine a subblock motion field from spatial neighbor blocks. The subblock motion field of a current CU may be inherited based on motion information of the spatial neighbor blocks. FIGS. 4A-4E illustrate examples of different SbSMVP candidate types, in which subblock motion vectors are inherited directionally.

As shown in FIG. 4A, a current block (402) includes 16 subblocks, such as a subblock (408). The current block (402) may include a first subblock motion vector field (404) determined based on a plurality of top neighboring subblocks (e.g., neighboring subblock (410)) positioned at a top side of the current block (402) and a second subblock motion vector field (406) determined based on a plurality of side neighboring subblocks (e.g., neighboring subblock (412)) positioned at a left side of the current block (402). In an example of FIG. 4A, according to a horizontal direction, motion vectors for the subblocks of the current block (402) are determined based on the second subblock motion vector field (406). For example, according to the horizontal direction, the motion vector of the subblock (408) of the current block (402) is determined as a motion vector MV₈ of the neighboring subblock (412) in the second subblock motion vector field (406).

In an example of FIG. 4B, according to a vertical direction, motion vectors for the subblocks of the current block (402) are determined based on the first subblock motion vector field (404). For example, according to the vertical direction, the motion vector of the subblock (408) of the current block (402) is determined as a motion vector MV₃ of the neighboring subblock (410) in the first subblock motion vector field (404).

In an example of FIG. 4C, according to a diagonal direction, motion vectors for the subblocks of the current block (402) are determined based on both the first subblock motion vector field (404) and the second subblock motion vector field (406). For example, according to the diagonal direction, the motion vector of the subblock (408) of the current block (402) is determined as a motion vector MV₅ of the neighboring subblock (414). The motion vector of the subblock (407) of the current block (402) is determined as a motion vector MV₃ of the neighboring subblock (410).

In an example of FIG. 4D, the second subblock motion vector field (406) is determined based on the plurality of side neighboring subblocks (e.g., neighboring subblock (412)) positioned at a left side of the current block (402). The plurality of side neighboring subblocks may include subblocks (e.g., neighboring subblock (416)) that are positioned under a bottom side (402A) of the current block (402). In an example of FIG. 4D, according to a diagonal direction, motion vectors for the subblocks of the current block (402) are determined based on the second subblock motion vector field (406). For example, according to the diagonal direction, the motion vector of the subblock (408) of the current block (402) is determined as a motion vector MV₁₇ of the neighboring subblock (416).

In an example of FIG. 4E, the first subblock motion vector field (404) is determined based on the plurality of top neighboring subblocks (e.g., neighboring subblock (410)) positioned at the top side of the current block (402). The plurality of top neighboring subblocks may include subblocks (e.g., neighboring subblock (418)) that are positioned beyond a right side (402B) of the current block (402). In an example of FIG. 4E, according to a diagonal direction, motion vectors for the subblocks of the current block (402) are determined based on the first subblock motion vector field (404). For example, according to the diagonal direction, the motion vector of the subblock (408) of the current block (402) is determined as a motion vector MV₁₂ of the neighboring subblock (418).

Aspects of the disclosure includes methods and apparatuses to determine (e.g., derive) subblock-based bi-directional spatial motion vector fields. A subblock-level motion field for a coding block may be determined from plural directions. For example, the subblock-level motions field may not only be determined from one direction but also be determined from another direction (e.g., an opposite direction) if a motion field at the other direction (e.g., the opposite direction) is available.

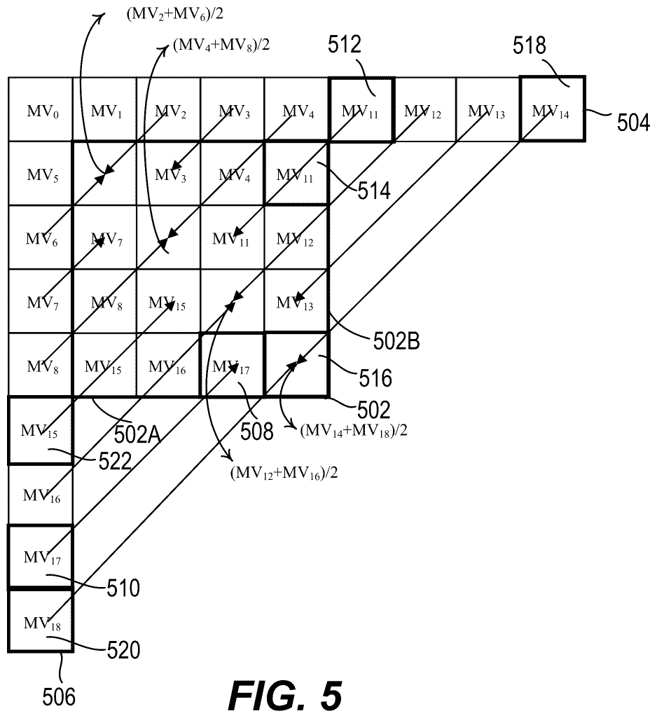

In an aspect, an average of bi-directional spatial motion fields is used to determine subblock-based bi-directional spatial motion vector fields. FIG. 5 shows an example of subblock-based bi-directional spatial motion vector field derivation.

As shown in FIG. 5, a current block (502) includes a plurality of subblocks, such as subblocks (508), (514), and (516). The current block (502) may include a first subblock motion vector field (504) based on a plurality of top neighboring subblocks (e.g., neighboring subblock (512)) positioned at a top side of the current block (502) and a second subblock motion vector field (506) based on a plurality of side neighboring subblocks (e.g., neighboring subblock (510)) positioned at a left side of the current block (502). In an example of FIG. 5, the plurality of top neighboring subblocks may include subblocks (e.g., neighboring subblock (518)) that are positioned beyond a right side (502B) of the current block (502). The plurality of side neighboring subblocks may include subblocks (e.g., neighboring subblock (510)) that are positioned below a bottom side (502A) of the current block (502). In an example, motion vectors of the subblocks of the current block (502) are determined based on both the first subblock motion vector field (504) and the second subblock motion vector filed (506) according to a spatial direction, distances between the subblocks and the neighboring subblocks, and positions of the subblocks in the current block.

In an example of FIG. 5, the spatial direction is at a 45-degree angle (or a diagonal direction). According to the spatial direction, for a subblock, such as the subblock (514), that is not positioned at a diagonal of the current block (502), a motion vector of the subblock (514) may be determined based on a motion vector MV₁₁ of the top neighboring subblock (512) in the first subblock motion vector field (504) or a motion vector MV₁₅ of the side neighboring subblock (522) in the second subblock motion vector field (506). However, a distance between the subblock (514) and the top neighboring subblock (512) is less than a distance between the subblock (514) and the side neighboring subblock (522). Thus, the motion vector of the subblock (514) is determined based on the motion vector MV₁₁ of the top neighboring subblock (512). In an example, the motion vector of the subblock (514) is determined as the motion vector MV₁₁ of the top neighboring subblock (512).

Still referring to FIG. 5, when a subblock, such as the subblock (516), is positioned at the diagonal of the current block (502), the motion vector of the subblock (516) is determined based on average of bi-directional spatial motion fields. For example, the motion vector of the subblock (516) is determined based on an average of the motion vector MV₁₈ of the side neighboring subblock (520) and the motion vector MV₁₄ of the top neighboring subblock (518). In an example, the motion vector of the subblock (516) is determined as the average of the motion vector MV₁₈ of the side neighboring subblock (520) and the motion vector MV₁₄ of the top neighboring subblock (518).

In an aspect, the area of the average two motion fields can be different depending on the coding block size. In an example, an area of an average of two motion fields (e.g., the first and second subblock motion vector fields (504) and (506)) is defined based on a coding block size, such as the size of the current block (502). In an example, an area of the first subblock motion vector field (504) or an area of the second subblock motion vector field (506) is defined based on the size of the current block (502).

In an aspect, the area of the average two motion fields is determined by the distance between the subblock position and the corresponding spatial neighboring block. In an example, the area of the first subblock motion vector field (504) is defined based on distances between the subblocks of the current block (502) and the top neighboring subblocks. In an example, the area of the second subblock motion vector field (506) is defined based on distances between the subblocks of the current block (502) and the side neighboring subblocks.

In an aspect, one of two motion fields from bi-directional spatial neighboring blocks (or subblocks) is used when a subblock position is at a center of a spatial bi-direction.

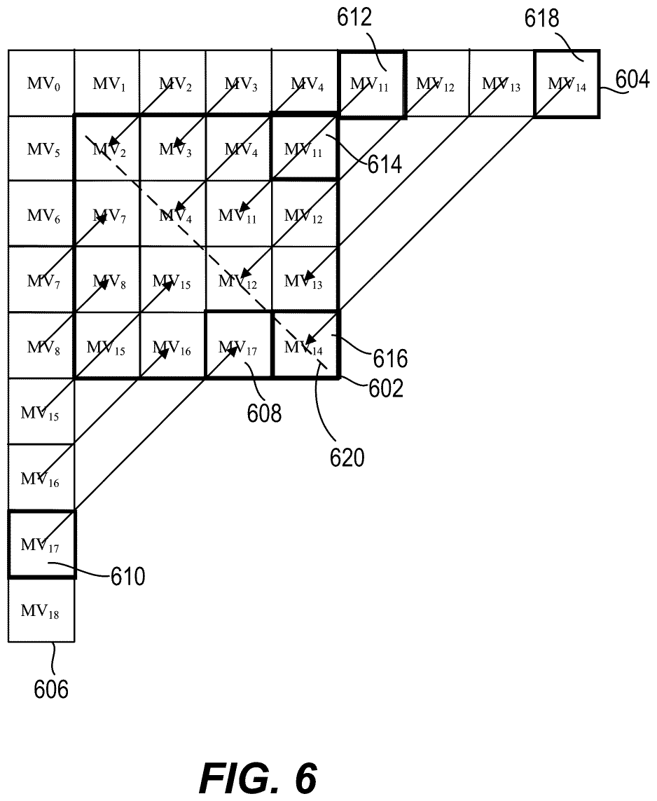

In an example of FIG. 6, a current block (602) includes a plurality of subblocks, such as subblocks (608), (614), and (616). The current block (602) includes a first subblock motion vector field (604) based on a plurality of top neighboring subblocks (e.g., neighboring subblock (612)) positioned at a top side of the current block (602) and a second subblock motion vector field (606) based on a plurality of side neighboring subblocks (e.g., neighboring subblock (610)) positioned at a left side of the current block (602). In an example, motion vectors of subblocks of the current block (602) that are positioned at a diagonal (620) or positioned above the diagonal (620) are determined based on the first subblock motion vector field (604), and motion vectors of subblocks of the current block (602) that are positioned under the diagonal (620) are determined based on the second subblock motion vector field (606). For example, the subblock (616) is positioned at the diagonal (620). The motion vector of the subblock (616) is determined based on motion vector MV₁₄ of the top neighboring subblock (618). The subblock (614) is positioned above the diagonal (620). The motion vector of the subblock (614) is determined based on motion vector MV₁₁ of the top neighboring subblock (612). The subblock (608) is positioned under the diagonal (620). The motion vector of the subblock (608) is determined based on motion vector V₁₇ of the side neighboring subblock (610).

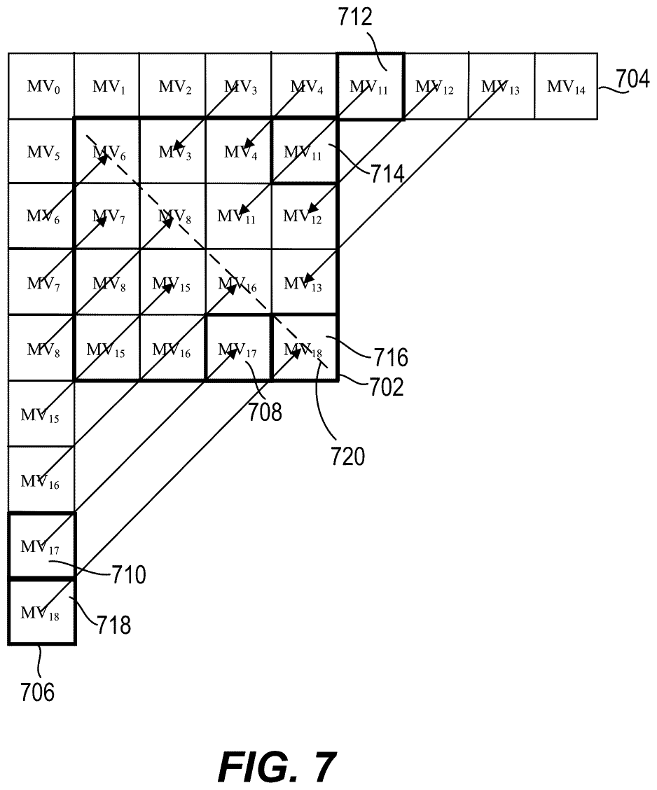

In an example of FIG. 7, a current block (702) includes a plurality of subblocks, such as subblocks (708), (714), and (716). The current block (702) includes include a first subblock motion vector field (704) based on a plurality of top neighboring subblocks (e.g., neighboring subblock (712)) positioned at a top side of the current block (702) and a second subblock motion vector field (706) based on a plurality of side neighboring subblocks (e.g., neighboring subblock (710)) positioned at a left side of the current block (702). In an example, motion vectors of subblocks of the current block (702) that are positioned at a diagonal (720) or positioned below the diagonal (720) are determined based on the second subblock motion vector field (706), and motion vectors of subblocks of the current block (702) that are positioned above the diagonal (720) are determined based on the first subblock motion vector field (704). For example, the subblock (716) is positioned at the diagonal (720) and the motion vector of the subblock (716) is determined based on motion vector MV₁₈ of the side neighboring subblock (718). The subblock (714) is positioned above the diagonal (720) and the motion vector of the subblock (714) is determined based on motion vector MV₁₁ of the top neighboring subblock (712). The subblock (708) is positioned under the diagonal (720) and the motion vector of the subblock (708) is determined based on motion vector V₁₇ of the side neighboring subblock (710).

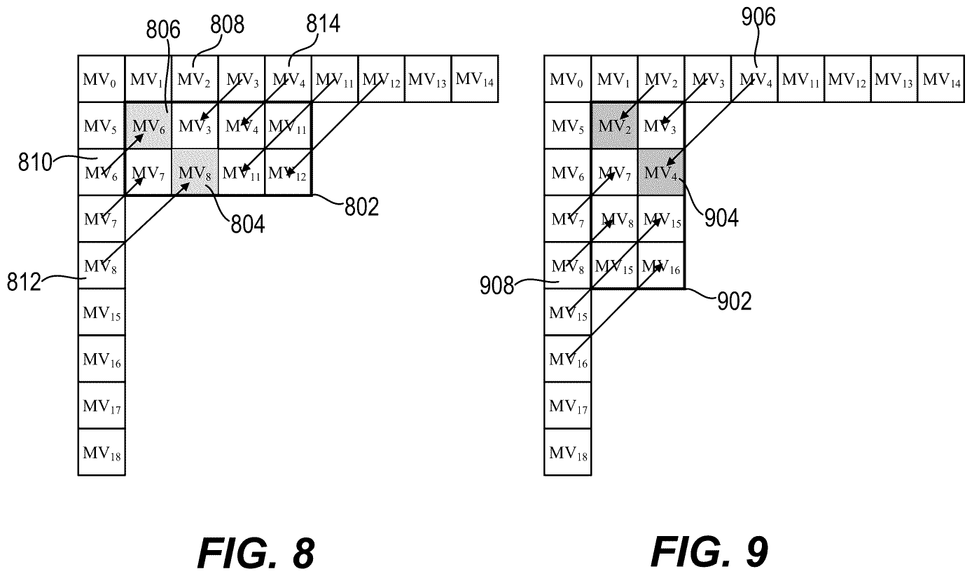

In an aspect, a spatial neighboring block is adaptively inherited based on a block shape of the current block. In an example, as shown in FIG. 8, a current block (802) has a size of 16×8 samples, and each MV field (or each subblock) has a size of 4×4 samples. As shown in the current block (802), a subblock (804) has an equal distance to a top right neighboring subblock (814) that has a motion vector MV₄ and a bottom left neighboring subblock (812) that has a motion vector of MV₈. A subblock (806) has an equal distance to a top right neighboring subblock (808) that has a motion vector MV₂ and a bottom left neighboring subblock (810) that has a motion vector of MV₆.

In an example of FIG. 8, when a MV of a subblock of the current block (802) that has a same distance to a top neighboring block and a side neighboring block according to a spatial direction is inherited from a predefined edge, such as a short edge. For example, the subblock (804) has a same distance to the side neighboring subblock (812) and the top neighboring subblock (814). The side neighboring subblock (812) is positioned at the short edge. Thus, the motion vector of the subblock (804) is determined based on the motion vector MV₈ of the side neighboring subblock (812). In an example of FIG. 9, when a current block (902) has a size of 8×16 samples, a motion vector of a subblock (904) of the current block (902) is inherited from a motion vector MV₄ of a top neighboring subblock (906) at a short edge of the current block (902) when the subblock (904) has a same distance to the top neighboring subblock (906) and a side neighboring subblock (908).

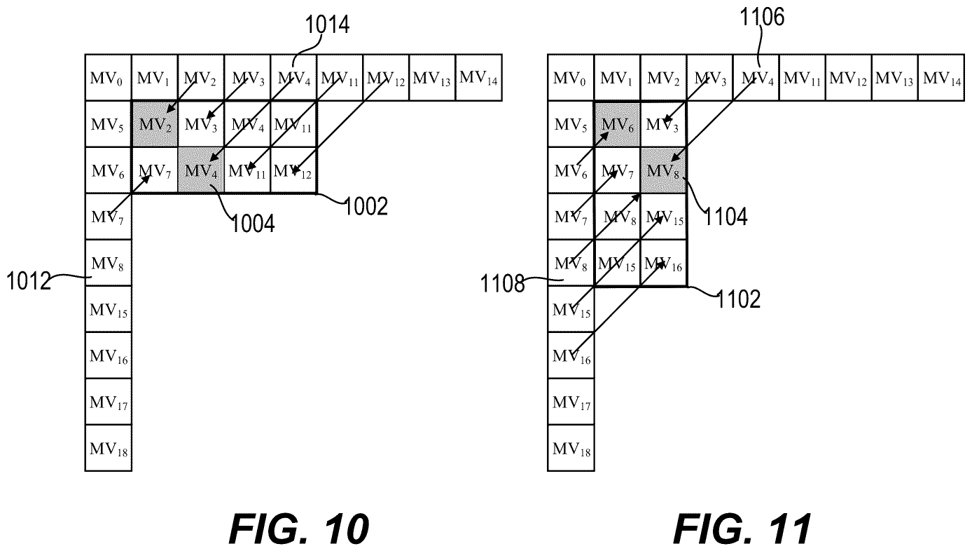

In an example of FIG. 10, a coding block size of a current block (1002) has a size of 16×8 samples, and a subblock size of a subblock for a MV field is 4×4 samples, a MV of a subblock that has a same distance to a top neighboring block and a side neighboring block according to a spatial direction is inherited from a predefined edge, such as a long edge. For example, a subblock (1004) has a same distance to the side neighboring subblock (1012) and the top neighboring subblock (1014). The top neighboring subblock (1014) is positioned at the long edge. Thus, the motion vector of the subblock (1004) is determined based on the motion vector MV₄ of the top neighboring subblock (1014). In an example of FIG. 11, when a current block (1102) has a size of 8×16 samples, a motion vector of a subblock (1104) is inherited from a motion vector MV₈ of a side neighboring subblock (1108) at a long edge of the current block (1102) when the subblock (1104) has a same distance to the top neighboring subblock (1106) and a side neighboring subblock (1108).

Aspects of disclosure include determining motion vector information for a spatial neighboring block when at least one associated motion field is not available at the corresponding spatial neighboring block when SbSMVP is selected and associated spatial neighbor motion fields of the SbSMVP are used.

In an aspect, when a spatial neighboring block of a current block that is marked as unavailable in terms of motion field information has a block vector (BV) that points to a reconstructed region (or reconstructed block) of a coded picture, the BV is then used by SbSMVP to obtain subblock-level prediction samples from the reconstructed region. In an example, samples in the reconstructed region are applied as reference samples for the current block.

In an aspect, when a spatial neighboring block of a current block that is marked as unavailable in terms of motion field information has a BV, and the BV points to a reconstructed region of the coded picture, motion field information (e.g., motion vector or block vector) is determined at the coded block (or reconstructed region) pointed by the BV. For example, a motion vector or a block vector of the reconstructed region of the coded picture is applied to determine the motion field information of the spatial neighboring block that has no available motion field. In an example, the determined motion field information is used for the subblock-level motion field information.

In an example, the determined motion field information is scaled based on a ratio of a temporal distance between a current picture and a reference picture pointed by the motion field (e.g., BV) over a temporal distance between the current picture and a target reference picture.

In an example, the BV is added on top of the determined motion field information according to the reconstructed region to construct a final subblock-level motion field of SbSMVP. In an example, the final subblock-level motion field is determined based on the BV and the determined motion field information. In an example, the final subblock-level motion field is determined as a sum of the BV and the determined motion field information.

In an example, the determined motion field information is directly used to construct a final subblock-level motion field of SbSMVP.

In an aspect, neither a motion vector nor a block vector is available at an associated neighboring subblock, motion vector information or block vector information at the associated neighboring subblock is determined from a closest neighboring subblock to the associated neighboring subblock when the closest neighboring subblock has motion vector information or block vector information.

In an aspect, neither a motion vector nor a block vector is available at an associated neighboring subblock, motion vector information of the associated neighboring subblock is determined from motion vector information of a neighboring subblock at a predefined position, such as top-left corner, MV₀, as shown in FIG. 4A.

In an aspect, a motion vector is not available at an associated neighboring subblock, the motion vector is determined from motion vector information of a neighboring subblock at a predefined position, such as at a top-left corner, MV₀, as shown in FIG. 4A.

In an aspect, SbSMVP is not available when motion vector information at a predefined position of a current block, such as at a top-left corner, MV₀, is not available.

Aspects of the disclosure include determining an inherited MV field direction based on a coding block size and/or a block shape of a coding block when the coding block is a non-square block. In an example, a MV field direction, which is not from a short edge of the coding block, is used for subblock-based bi-directional spatial motion vector field derivation.

In an aspect, a direction of horizontal and/or a direction of diagonal shown in FIGS. 4A and 4C-4E are not allowed when an aspect ratio of a width of a current block and a height of the current block, blockWidth/blkHeight, is larger than and/or equal to a predefined threshold value γ_{W/H}. An example of the threshold value γ_{W/H} is 2.

In an example, different block widths have different predefined threshold values γ_{W/H}.

In an aspect, the direction of horizontal and/or the direction of diagonal shown in FIGS. 4A and 4C-4E are not allowed when the height of the current block is smaller than and/or equal to a predefined threshold value τ. An example of the threshold value τ is 8.

In an aspect, a direction of vertical and/or the direction of diagonal shown in FIGS. 4B and 4C-4E are not allowed when an aspect ratio of a width of a current block and a height of the current block, blockHeight/blkWidth, is larger than and/or equal to a predefined threshold value γ_{H/W}. An example of the threshold value γ_{H/W} is 2.

In an aspect, different block heights have different predefined threshold values γ_{H/W}.

In an aspect, the direction of vertical and/or the direction of diagonal shown in FIGS. 4B and 4C-4E are not allowed when the width of the current block is smaller than and/or equal to a predefined threshold value τ. An example of the threshold value τ is 8.

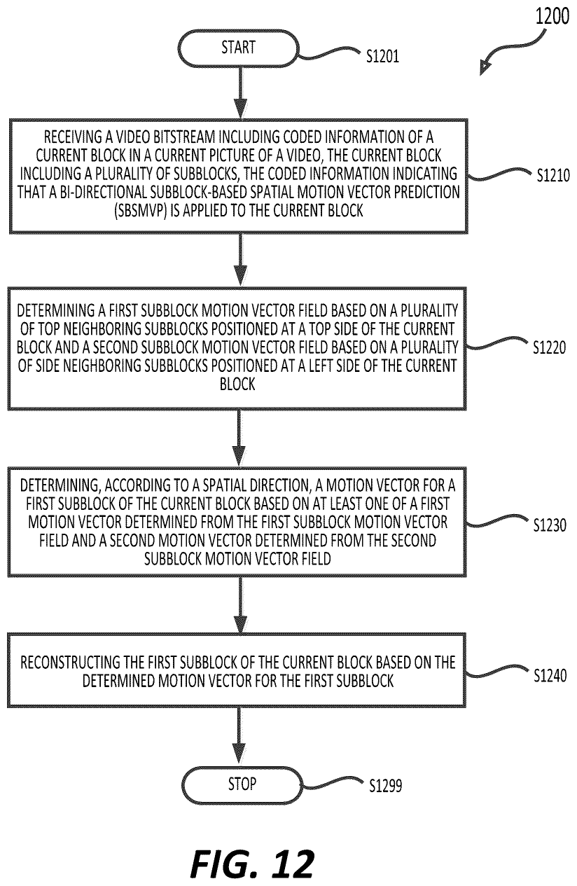

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a video bitstream including coded information of a current block in a current picture of a video is received. The current block includes a plurality of subblocks. The coded information indicates that a bi-directional SbSMVP is applied to the current block.

At (S1220), a first subblock motion vector field is determined based on a plurality of top neighboring subblocks positioned at a top side of the current block. A second subblock motion vector field is determined based on a plurality of side neighboring subblocks positioned at a left side of the current block.

At (S1230), according to a spatial direction, a motion vector for a first subblock of the current block is determined based on at least one of a first motion vector determined from the first subblock motion vector field and a second motion vector determined from the second subblock motion vector field.

At (S1240), the first subblock of the current block is reconstructed based on the determined motion vector for the first subblock.

In an aspect, an area of the first subblock motion vector field and an area of the second subblock motion vector field are based on a size of the current block. The first subblock motion vector field is determined based on a distance between the first subblock and each of the plurality of top neighboring subblocks.

In an aspect, the motion vector for the first subblock is determined as one of the first motion vector and the second motion vector based on a relative position of the first subblock with respect to a diagonal of the current block.

In an aspect, when the first subblock is positioned on a diagonal of the current block, the motion vector for the first subblock of the current block is determined based on an average of the first motion vector and the second motion vector. When the first subblock is not positioned on the diagonal of the current block, the motion vector for the first subblock is determined as the first motion vector when the first subblock motion vector field is closer to the first subblock motion vector field than the second subblock motion vector field.

In an aspect, a first neighboring subblock is determined from the plurality of top neighboring subblocks based on the spatial direction and a first distance between a center of the first neighboring subblock and a center of the first subblock of the current block. A second neighboring subblock is determined from the plurality of side neighboring subblocks based on the spatial direction and a second distance between a center of the second neighboring subblock and the center of the first subblock of the current block. The first motion vector is determined based on motion vector information of the first neighboring subblock. The second motion vector is determined based on motion vector information of the second neighboring subblock.

In an aspect, the motion vector for the first subblock is determined as one of the first motion vector and the second motion vector that corresponds to a neighboring subblock positioned at a predefined side of the current block.

In an aspect, the first motion vector is determined based on a first neighboring subblock that is positioned in the plurality of top neighboring subblocks and the second motion vector is determined based on a second neighboring subblock that is positioned in the plurality of side neighboring subblocks. When a distance between the first subblock and the first neighboring subblock according to the spatial direction is equal to a distance between the first subblock and the second neighboring subblock according to the spatial direction, the motion vector for the first subblock is determined as one of the first motion vector and the second motion vector. The one of the first motion vector and the second motion vector corresponds to one of the first neighboring subblock and the second neighboring subblock that is positioned at a predefined side of the current block.

In an aspect, when motion vector information of a neighboring subblock of the first subblock that is determined according to the spatial direction in the plurality of top neighboring subblocks is not available, the first motion vector is determined based on a block vector of the neighboring subblock of the first subblock in the plurality of top neighboring subblocks.

In an aspect, when motion vector information of a neighboring subblock of the first subblock that is determined according to the spatial direction in the plurality of top neighboring subblocks is not available, a reconstructed region of a reference picture is determined based on an indication of a block vector of the neighboring subblock of the first subblock in the plurality of top neighboring subblocks. The first motion vector is determined based on motion field information of the reconstructed region of the reference picture.

In an aspect, the motion field information is scaled based on a ratio of a temporal distance between the current picture and the reference picture to and a temporal distance between the current picture and a target reference picture obtain scaled motion field information. The first motion vector is determined based on the scaled motion field information.

In an aspect, the motion field information is scaled based on a ratio of a temporal distance between the current picture and the reference picture and a temporal distance between the current picture and a target reference picture to obtain scaled motion field information. The first motion vector is determined based on the block vector of the neighboring subblock of the first subblock and the scaled motion field information.

In an aspect, when motion vector information of a neighboring subblock of the first subblock that is determined according to the spatial direction in the plurality of top neighboring subblocks is not available, the first motion vector is determined based on motion field information of a subblock closest to the neighboring subblock of the first subblock in the plurality of top neighboring subblocks.

In an aspect, when motion vector information of a neighboring subblock of the first subblock that is determined according to the spatial direction in the plurality of top neighboring subblocks is not available, the first motion vector is determined based on motion vector information of a neighboring subblock at a top-left corner of the current block.

In an aspect, the coded information indicates that the bi-directional SbSMVP is not to be applied to the current block when motion vector information of a neighboring subblock at a top-left corner of the current block is not available.

In an aspect, the spatial direction is not a horizontal direction or a diagonal direction when an aspect ratio of a width of the current block and a height of the current block is equal to or larger than a threshold value.

In an aspect, the spatial direction is not a horizontal direction or a diagonal direction when a height of the current block is equal to or smaller than a threshold value.

In an aspect, the spatial direction is not a vertical direction or a diagonal direction when a ratio of a height of the current block and a width of the current block is equal to or larger than a threshold value.

In an aspect, the spatial direction is not a vertical direction or a diagonal direction when a width of the current block is equal to or smaller than a threshold value.

Then, the process proceeds to (S1299) and terminates.

The process (1200) can be suitably adapted. Step(s) in the process (1200) can be modified and/or omitted. Additional step(s) can be added. Any suitable order of implementation can be used.

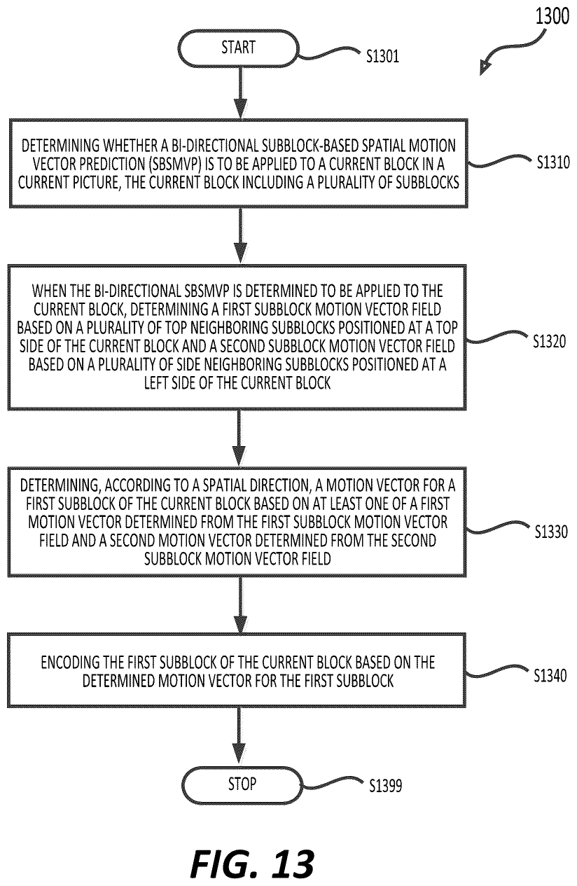

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), whether a bi-directional SbSMVP is to be applied to a current block in a current picture is determined. The current block includes a plurality of subblocks.

At (S1320), when the bi-directional SbSMVP is determined to be applied to the current block, a first subblock motion vector field is determined based on a plurality of top neighboring subblocks positioned at a top side of the current block and a second subblock motion vector field is determined based on a plurality of side neighboring subblocks positioned at a left side of the current block.

At (S1330), according to a spatial direction, a motion vector for a first subblock of the current block is determined based on at least one of a first motion vector determined from the first subblock motion vector field and a second motion vector determined from the second subblock motion vector field.

At (S1340), the first subblock of the current block is encoded based on the determined motion vector for the first subblock.

Then, the process proceeds to (S1399) and terminates.

The process (1300) can be suitably adapted. Step(s) in the process (1300) can be modified and/or omitted. Additional step(s) can be added. Any suitable order of implementation can be used.

In an aspect, a non-transitory computer-readable storage medium is provided. The non-transitory computer-readable storage medium stores instructions which when executed by a processor cause the processor to perform an encoding method. In the encoding method, whether a bi-directional SbSMVP is to be applied to a current block in a current picture is determined. The current block includes a plurality of subblocks. When the bi-directional SbSMVP is determined to be applied to the current block, a first subblock motion vector field is determined based on a plurality of top neighboring subblocks positioned at a top side of the current block. A second subblock motion vector field is determined based on a plurality of side neighboring subblocks positioned at a left side of the current block. According to a spatial direction, a motion vector for a first subblock of the current block is determined based on at least one of a first motion vector determined from the first subblock motion vector field and a second motion vector determined from the second subblock motion vector field. The first subblock of the current block is encoded in a bitstream based on the determined motion vector for the first subblock. The encoded bitstream is further transmitted.

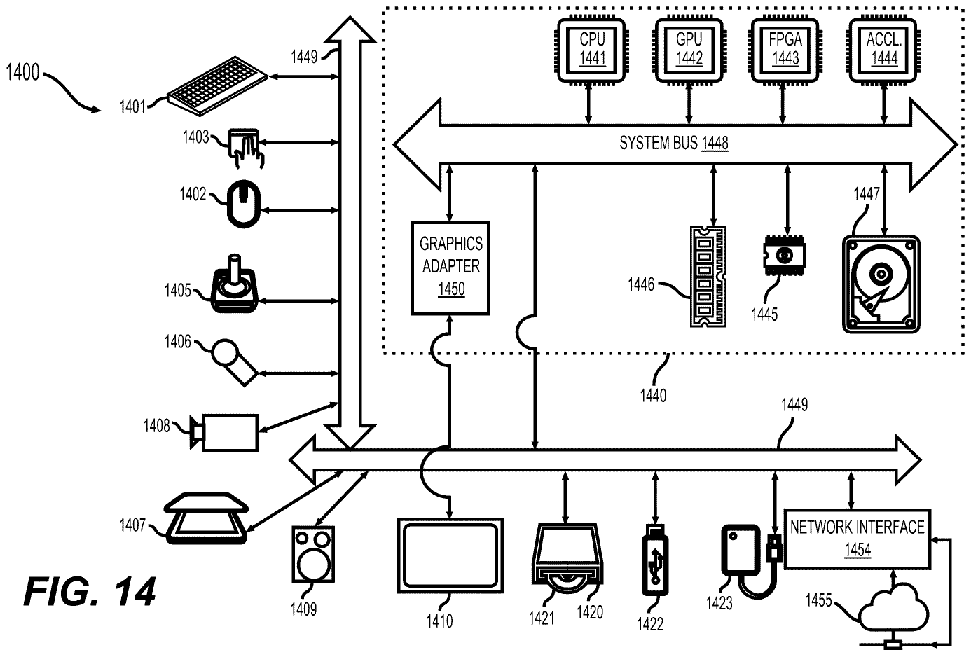

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method of video decoding, including: receiving a video bitstream including coded information of a current block in a current picture of a video, the current block including a plurality of subblocks, the coded information indicating that a bi-directional subblock-based spatial motion vector prediction (SbSMVP) is applied to the current block; determining a first subblock motion vector field based on a plurality of top neighboring subblocks positioned at a top side of the current block and a second subblock motion vector field based on a plurality of side neighboring subblocks positioned at a left side of the current block; determining, according to a spatial direction, a motion vector for a first subblock of the current block based on at least one of a first motion vector determined from the first subblock motion vector field and a second motion vector determined from the second subblock motion vector field; and reconstructing the first subblock of the current block based on the determined motion vector for the first subblock.
(2) The method of feature (1), in which an area of the first subblock motion vector field and an area of the second subblock motion vector field are based on a size of the current block. The first subblock motion vector field is determined based on a distance between the first subblock and each of the plurality of top neighboring subblocks.
(3) The method of feature (1) or (2), in which the determining the motion vector further includes: determining the motion vector for the first subblock as one of the first motion vector and the second motion vector based on a relative position of the first subblock with respect to a diagonal of the current block.
(4) The method of any one of features (1) to (3), in which the determining the motion vector further includes: when the first subblock is positioned on a diagonal of the current block, determining the motion vector for the first subblock of the current block based on an average of the first motion vector and the second motion vector, and when the first subblock is not positioned on the diagonal of the current block, determining the motion vector for the first subblock as the first motion vector when the first subblock motion vector field is closer to the first subblock motion vector field than the second subblock motion vector field.
(5) The method of any one of features (1) to (4), in which the determining further includes: determining a first neighboring subblock from the plurality of top neighboring subblocks based on the spatial direction and a first distance between a center of the first neighboring subblock and a center of the first subblock of the current block; determining a second neighboring subblock from the plurality of side neighboring subblocks based on the spatial direction and a second distance between a center of the second neighboring subblock and the center of the first subblock of the current block; determining the first motion vector based on motion vector information of the first neighboring subblock; and determining the second motion vector based on motion vector information of the second neighboring subblock.
(6) The method of any one of features (1) to (5), in which the determining the motion vector further includes: determining the motion vector for the first subblock as one of the first motion vector and the second motion vector that corresponds to a neighboring subblock positioned at a predefined side of the current block.
(7) The method of any one of features (1) to (6), in which the first motion vector is determined based on a first neighboring subblock that is positioned in the plurality of top neighboring subblocks and the second motion vector is determined based on a second neighboring subblock that is positioned in the plurality of side neighboring subblocks, and the determining further includes: when a distance between the first subblock and the first neighboring subblock according to the spatial direction is equal to a distance between the first subblock and the second neighboring subblock according to the spatial direction, determining the motion vector for the first subblock as one of the first motion vector and the second motion vector, the one of the first motion vector and the second motion vector corresponding to one of the first neighboring subblock and the second neighboring subblock that is positioned at a predefined side of the current block.
(8) The method of any one of features (1) to (7), in which the determining the motion vector for the first subblock further includes: when motion vector information of a neighboring subblock of the first subblock that is determined according to the spatial direction in the plurality of top neighboring subblocks is not available, determining the first motion vector based on a block vector of the neighboring subblock of the first subblock in the plurality of top neighboring subblocks.
(9) The method of any one of features (1) to (8), in which the determining the motion vector further includes: when motion vector information of a neighboring subblock of the first subblock that is determined according to the spatial direction in the plurality of top neighboring subblocks is not available, determining a reconstructed region of a reference picture that is indicated by a block vector of the neighboring subblock of the first subblock in the plurality of top neighboring subblocks; and determining the first motion vector based on motion field information of the reconstructed region of the reference picture.
(10) The method of feature (9), in which the determining the first motion vector further includes: scaling the motion field information based on a ratio of a temporal distance between the current picture and the reference picture to obtain scaled motion field information; and determining the first motion vector based on the scaled motion field information.
(11) The method of feature (9), in which the determining the first motion vector further includes: scaling the motion field information based on a ratio of a temporal distance between the current picture and the reference picture to obtain scaled motion field information; and determining the first motion vector based on the block vector of the neighboring subblock of the first subblock and the scaled motion field information.
(12) The method of any one of features (1) to (11), in which the determining the first motion vector further includes: when motion vector information of a neighboring subblock of the first subblock that is determined according to the spatial direction in the plurality of top neighboring subblocks is not available, determining the first motion vector based on motion field information of a subblock closest to the neighboring subblock of the first subblock in the plurality of top neighboring subblocks.
(13) The method of any one of features (1) to (12), in which the determining the first motion vector further includes: when motion vector information of a neighboring subblock of the first subblock that is determined according to the spatial direction in the plurality of top neighboring subblocks is not available, determining the first motion vector based on motion vector information of a neighboring subblock at a top-left corner of the current block.
(14) The method of any one of features (1) to (13), in which the coded information indicates that the bi-directional SbSMVP is not to be applied to the current block when motion vector information of a neighboring subblock at a top-left corner of the current block is not available.
(15) The method of any one of features (1) to (14), in which the spatial direction is not a horizontal direction or a diagonal direction when an aspect ratio of a width of the current block and a height of the current block is equal to or larger than a threshold value.
(16) The method of any one of features (1) to (15), in which the spatial direction is not a horizontal direction or a diagonal direction when a height of the current block is equal to or smaller than a threshold value.
(17) The method of any one of features (1) to (16), in which the spatial direction is not a vertical direction or a diagonal direction when a ratio of a height of the current block and a width of the current block is equal to or larger than a threshold value.
(18) The method of any one of features (1) to (17), in which the spatial direction is not a vertical direction or a diagonal direction when a width of the current block is equal to or smaller than a threshold value.
(19) A method of video encoding, including: determining whether a bi-directional subblock-based spatial motion vector prediction (SbSMVP) is to be applied to a current block in a current picture, the current block including a plurality of subblocks; when the bi-directional SbSMVP is determined to be applied to the current block, determining a first subblock motion vector field based on a plurality of top neighboring subblocks positioned at a top side of the current block and a second subblock motion vector field based on a plurality of side neighboring subblocks positioned at a left side of the current block; determining, according to a spatial direction, a motion vector for a first subblock of the current block based on at least one of a first motion vector determined from the first subblock motion vector field and a second motion vector determined from the second subblock motion vector field; and encoding the first subblock of the current block based on the determined motion vector for the first subblock.
(20) A non-transitory computer-readable storage medium storing instructions which when executed by a processor cause the processor to perform an encoding method including: determining whether a bi-directional subblock-based spatial motion vector prediction (SbSMVP) is to be applied to a current block in a current picture, the current block including a plurality of subblocks; when the bi-directional SbSMVP is determined to be applied to the current block, determining a first subblock motion vector field based on a plurality of top neighboring subblocks positioned at a top side of the current block and a second subblock motion vector field based on a plurality of side neighboring subblocks positioned at a left side of the current block; determining, according to a spatial direction, a motion vector for a first subblock of the current block based on at least one of a first motion vector determined from the first subblock motion vector field and a second motion vector determined from the second subblock motion vector field; encoding the first subblock of the current block in a bitstream based on the determined motion vector for the first subblock; and transmitting the encoded bitstream.
(21) An apparatus for video decoding, including processing circuitry that is configured to perform the method of any one of features (1) to (18).
(22) An apparatus for video encoding, including processing circuitry that is configured to perform the method of feature (19).
(23) A non-transitory computer-readable storage medium storing instructions which when executed by at least one processor cause the at least one processor to perform the method of any one of features (1) to (19).

What is claimed is:

1. A method of video decoding, comprising:
receiving a video bitstream including coded information of a current block in a current picture of a video, the current block including a plurality of subblocks, the coded information indicating that a bi-directional subblock-based spatial motion vector prediction (SbSMVP) is applied to the current block;
determining a first subblock motion vector field based on a plurality of top neighboring subblocks positioned at a top side of the current block and a second subblock motion vector field based on a plurality of side neighboring subblocks positioned at a left side of the current block;
determining, according to a spatial direction, a motion vector for a first subblock of the current block based on at least one of a first motion vector determined from the first subblock motion vector field and a second motion vector determined from the second subblock motion vector field; and
reconstructing the first subblock of the current block based on the determined motion vector for the first subblock.

2. The method of claim 1, wherein:
an area of the first subblock motion vector field and an area of the second subblock motion vector field are based on a size of the current block, and
the first subblock motion vector field is determined based on a distance between the first subblock and each of the plurality of top neighboring subblocks.

3. The method of claim 1, wherein the determining the motion vector further comprises:
determining the motion vector for the first subblock as one of the first motion vector and the second motion vector based on a relative position of the first subblock with respect to a diagonal of the current block.

4. The method of claim 1, wherein the determining the motion vector further comprises:
when the first subblock is positioned on a diagonal of the current block, determining the motion vector for the first subblock of the current block based on an average of the first motion vector and the second motion vector, and
when the first subblock is not positioned on the diagonal of the current block, determining the motion vector for the first subblock as the first motion vector when the first subblock motion vector field is closer to the first subblock motion vector field than the second subblock motion vector field.

5. The method of claim 1, wherein the determining further comprises:
determining a first neighboring subblock from the plurality of top neighboring subblocks based on the spatial direction and a first distance between a center of the first neighboring subblock and a center of the first subblock of the current block;
determining a second neighboring subblock from the plurality of side neighboring subblocks based on the spatial direction and a second distance between a center of the second neighboring subblock and the center of the first subblock of the current block;
determining the first motion vector based on motion vector information of the first neighboring subblock; and
determining the second motion vector based on motion vector information of the second neighboring subblock.

6. The method of claim 1, wherein the determining the motion vector further comprises:
determining the motion vector for the first subblock as one of the first motion vector and the second motion vector that corresponds to a neighboring subblock positioned at a predefined side of the current block.

7. The method of claim 1, wherein:
the first motion vector is determined based on a first neighboring subblock that is positioned in the plurality of top neighboring subblocks and the second motion vector is determined based on a second neighboring subblock that is positioned in the plurality of side neighboring subblocks, and
the determining further comprises:
when a distance between the first subblock and the first neighboring subblock according to the spatial direction is equal to a distance between the first subblock and the second neighboring subblock according to the spatial direction,
determining the motion vector for the first subblock as one of the first motion vector and the second motion vector, the one of the first motion vector and the second motion vector corresponding to one of the first neighboring subblock and the second neighboring subblock that is positioned at a predefined side of the current block.

8. The method of claim 1, wherein the determining the motion vector for the first subblock further comprises:
when motion vector information of a neighboring subblock of the first subblock that is determined according to the spatial direction in the plurality of top neighboring subblocks is not available,
determining the first motion vector based on a block vector of the neighboring subblock of the first subblock in the plurality of top neighboring subblocks.

9. The method of claim 1, wherein the determining the motion vector further comprises:
when motion vector information of a neighboring subblock of the first subblock that is determined according to the spatial direction in the plurality of top neighboring subblocks is not available,
determining a reconstructed region of a reference picture that is indicated by a block vector of the neighboring subblock of the first subblock in the plurality of top neighboring subblocks; and
determining the first motion vector based on motion field information of the reconstructed region of the reference picture.

10. The method of claim 9, wherein the determining the first motion vector further comprises:
scaling the motion field information based on a ratio of a temporal distance between the current picture and the reference picture and a temporal distance between the current picture and a target reference picture to obtain scaled motion field information; and
determining the first motion vector based on the scaled motion field information.

11. The method of claim 9, wherein the determining the first motion vector further comprises:
scaling the motion field information based on a ratio of a temporal distance between the current picture and the reference picture and a temporal distance between the current picture and a target reference picture to obtain scaled motion field information; and
determining the first motion vector based on the block vector of the neighboring subblock of the first subblock and the scaled motion field information.

12. The method of claim 1, wherein the determining the first motion vector further comprises:
when motion vector information of a neighboring subblock of the first subblock that is determined according to the spatial direction in the plurality of top neighboring subblocks is not available,
determining the first motion vector based on motion field information of a subblock closest to the neighboring subblock of the first subblock in the plurality of top neighboring subblocks.

13. The method of claim 1, wherein the determining the first motion vector further comprises:
when motion vector information of a neighboring subblock of the first subblock that is determined according to the spatial direction in the plurality of top neighboring subblocks is not available,
determining the first motion vector based on motion vector information of a neighboring subblock at a top-left corner of the current block.

14. The method of claim 1, wherein the coded information indicates that the bi-directional SbSMVP is not to be applied to the current block when motion vector information of a neighboring subblock at a top-left corner of the current block is not available.

15. The method of claim 1, wherein the spatial direction is not a horizontal direction or a diagonal direction when an aspect ratio of a width of the current block and a height of the current block is equal to or larger than a threshold value.

16. The method of claim 1, wherein the spatial direction is not a horizontal direction or a diagonal direction when a height of the current block is equal to or smaller than a threshold value.

17. The method of claim 1, wherein the spatial direction is not a vertical direction or a diagonal direction when a ratio of a height of the current block and a width of the current block is equal to or larger than a threshold value.

18. The method of claim 1, wherein the spatial direction is not a vertical direction or a diagonal direction when a width of the current block is equal to or smaller than a threshold value.

19. A method of video encoding, comprising:
determining whether a bi-directional subblock-based spatial motion vector prediction (SbSMVP) is to be applied to a current block in a current picture, the current block including a plurality of subblocks;
when the bi-directional SbSMVP is determined to be applied to the current block, determining a first subblock motion vector field based on a plurality of top neighboring subblocks positioned at a top side of the current block and a second subblock motion vector field based on a plurality of side neighboring subblocks positioned at a left side of the current block;
determining, according to a spatial direction, a motion vector for a first subblock of the current block based on at least one of a first motion vector determined from the first subblock motion vector field and a second motion vector determined from the second subblock motion vector field; and
encoding the first subblock of the current block based on the determined motion vector for the first subblock.

20. A non-transitory computer-readable storage medium storing instructions which when executed by a processor cause the processor to perform an encoding method comprising:
determining whether a bi-directional subblock-based spatial motion vector prediction (SbSMVP) is to be applied to a current block in a current picture, the current block including a plurality of subblocks;
when the bi-directional SbSMVP is determined to be applied to the current block, determining a first subblock motion vector field based on a plurality of top neighboring subblocks positioned at a top side of the current block and a second subblock motion vector field based on a plurality of side neighboring subblocks positioned at a left side of the current block;
determining, according to a spatial direction, a motion vector for a first subblock of the current block based on at least one of a first motion vector determined from the first subblock motion vector field and a second motion vector determined from the second subblock motion vector field;
encoding the first subblock of the current block in a bitstream based on the determined motion vector for the first subblock; and
transmitting the encoded bitstream.
